(19) United States
(12) Patent Application Publication
(10) Pub. No.: US 2003/0057669 A1
(43) Pub. Date: Mar. 27, 2003

(54) Stroller with shock absorbing units

(76) Inventor: Red Lan, Taipei Hsien (TW)

Correspondence Address: BRINKS HOFER GILSON & LIONE, NBC Tower, Suite 3600, 455 N. Cityfront Plaza Drive, Chicago, IL, 60611-5599, US

(21) Appl. No.: 10/222,239

(22) Filed: Aug. 16, 2002

(30) Foreign Application Priority Data
Sep. 27, 2001 (GB) 0123347.7

(51) Int. Cl. B62B 7/00

(52) U.S. Cl. 280/47.38

(57) ABSTRACT

A stroller includes a front leg unit, first and second shock absorbing units, and a bridging member. The first shock absorbing unit includes an upper seat member that is connected to the front leg unit via the bridging member, and a pair of lower movable members that are connected to a front wheel unit and that are movable in a second axis toward and away from the upper seat member so as to absorb shock transmitted from the front wheel unit in the second axis when an external force is applied to the front wheel unit. The second shock absorbing unit includes at least one urging member that abuts against the bridging member and the upper seat member so as to oscillate between compression and extension strokes and so as to absorb shock transmitted from the front wheel unit in a third axis that is perpendicular to the second axis when the external force is applied to the front wheel unit.

### CROSS-REFERENCE TO RELATED APPLICATION

This application claims priority of United Kingdom Application No. 0123347.7, filed on Sep. 27, 2001.

### BACKGROUND OF THE INVENTION

1. Field of the Invention

This invention relates to a stroller, more particularly to a stroller with shock absorbing units.

2. Description of the Related Art

A conventional stroller normally includes a shock absorbing unit which is capable of absorbing shock transmitted from a front wheel unit in a second axis defined by a front leg unit when an external force is applied to the front wheel unit. However, since the front leg unit of the conventional stroller is normally inclined relative to the direction of the external force applied to the front wheel unit, another shock transmitted from the front wheel unit in a third axis relative to the second axis can not be absorbed by the shock absorbing unit.

### SUMMARY OF THE INVENTION

Therefore, the object of the present invention is to provide a stroller with shock absorbing units that are capable of overcoming the aforementioned drawback.

According to the present invention, there is provided a stroller which comprises: a stroller frame having a pair of opposing front legs that are inclined at an angle relative to a vertical line, and that have bottom ends; a front wheel unit disposed below and between the bottom ends of the front legs, and including a wheel and an axle that extends through a center of the wheel, that permits turning of the wheel thereabout, and that has two opposite ends; a bridging member disposed above the front wheel unit and having two opposite connecting ends that are respectively and securely connected to the bottom ends of the front legs; a first shock absorbing unit including an upper seat member that has a pivotal part disposed rearwardly of and pivoted to the bridging member so as to be turnable relative to the bridging member about a first axis that is parallel to the axle, the first shock absorbing unit further including a pair of lower movable members that are disposed below the upper seat member, and that are securely and respectively connected to the opposite ends of the axle and that are movable in a second axis toward and away from the upper seat member in so as to absorb shock transmitted from the front wheel unit in the second axis and so as to be turnable together with the front wheel unit about the first axis along with the upper seat member when an external force is applied to the wheel in an upward direction parallel to the vertical line; and a second shock absorbing unit including at least an urging member that is disposed between and that abuts against the bridging member and the upper seat member so as to oscillate between a transverse compression stroke, in which, the first shock absorbing unit turns together with the front wheel unit about the first axis against an urging force of the urging member toward the bridging member to compress the urging member, and a transverse extension stroke, in which, the urging member urges the first shock absorbing unit and the front wheel unit to turn away from the bridging member, thereby absorbing shock transmitted from the front wheel unit in a third axis that is perpendicular to the second axis when the external force is applied to the wheel.

### BRIEF DESCRIPTION OF THE DRAWINGS

In drawings which illustrate an embodiment of the invention,

FIG. 1 is a side view of a stroller with shock absorbing units embodying this invention;

FIG. 2 is a fragmentary perspective view of the shock absorbing units and a front wheel unit of the stroller of FIG. 1;

FIG. 3 is an exploded perspective view of the shock absorbing units and the front wheel unit of FIG. 2;

FIG. 4 is a sectional side view to illustrate the shock absorbing units of FIG. 2 during an extension stroke; and

FIG. 5 is a sectional side view to illustrate the shock absorbing units of FIG. 2 during a compression stroke.

### DETAILED DESCRIPTION OF THE PREFERRED EMBODIMENT

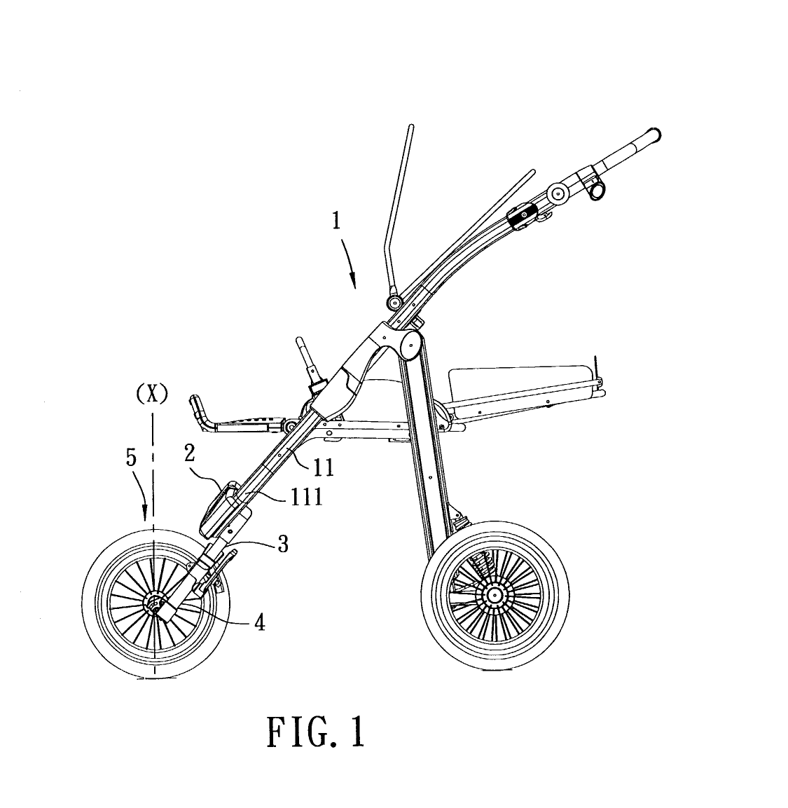

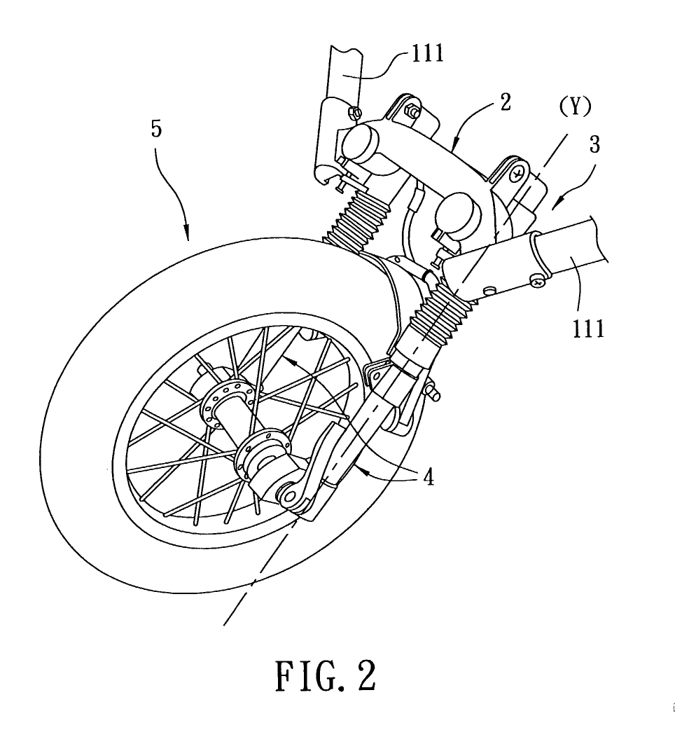

FIGS. 1 to 5 illustrate a stroller with first and second shock absorbing units embodying this invention.

The stroller includes: a stroller frame 1 having a pair of opposing front legs 11 that are inclined at an angle relative to a vertical line (X), and that have bottom ends 111; a front wheel unit 5 disposed below and between the bottom ends 111 of the front legs 11, and including a wheel 51 and an axle 52 that extends through a center of the wheel 51, that permits turning of the wheel 51 thereabout, and that has two opposite ends; and a bridging member 2 disposed above the front wheel unit 5 and having two opposite connecting ends 23 that are respectively and securely connected to the bottom ends 111 of the front legs 11.

The first shock absorbing unit includes an upper seat member 3 that has a pivotal part 30 disposed rearwardly of and pivoted to the bridging member 2 so as to be turnable relative to the bridging member 2 about a first axis that is parallel to the axle 52. The first shock absorbing unit further includes a pair of lower movable members 4 that are disposed below the upper seat member 3, and that are securely and respectively connected to the opposite ends of the axle 52 and that are movable in a second axis toward and away from the upper seat member 3 (Y) so as to absorb shock transmitted from the front wheel unit 5 in the second axis and so as to be turnable together with the front wheel unit 5 about the first axis along with the upper seat member 3 when an external force is applied to the wheel 51 in an upward direction parallel to the vertical line (X).

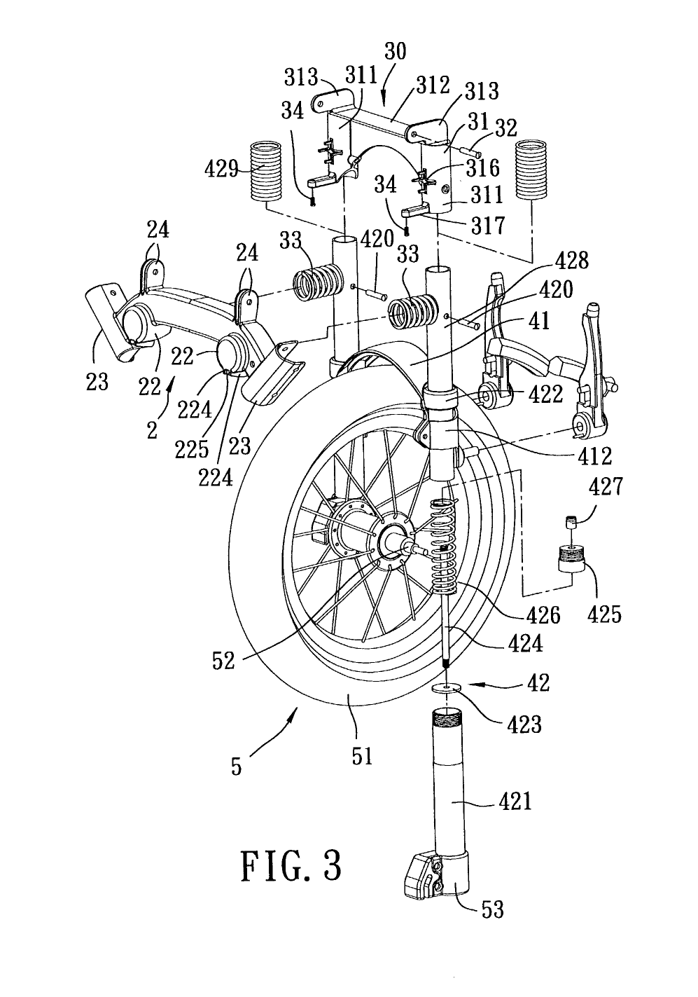

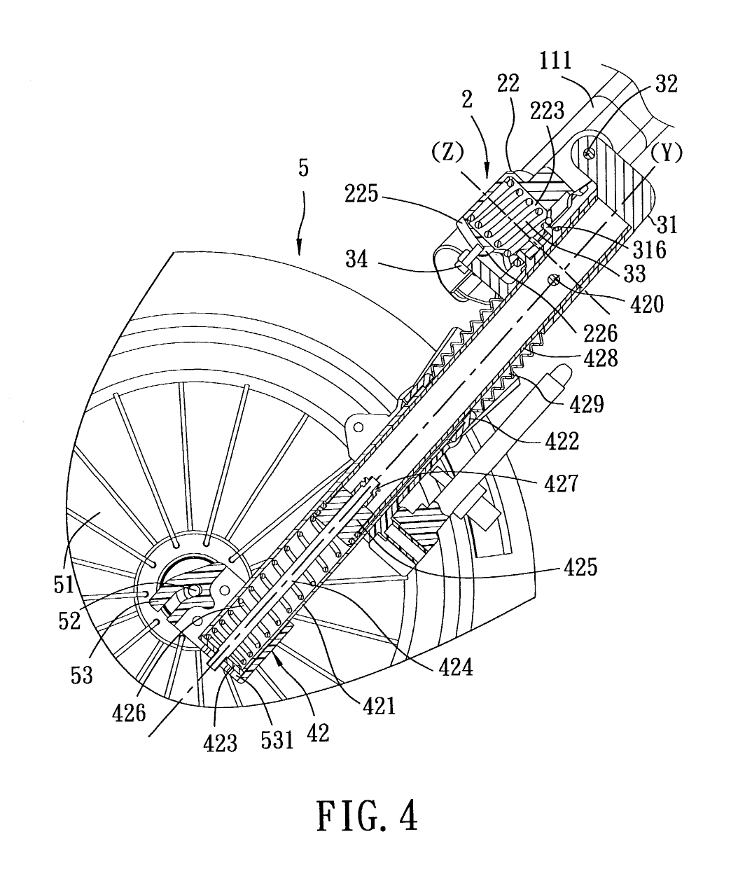

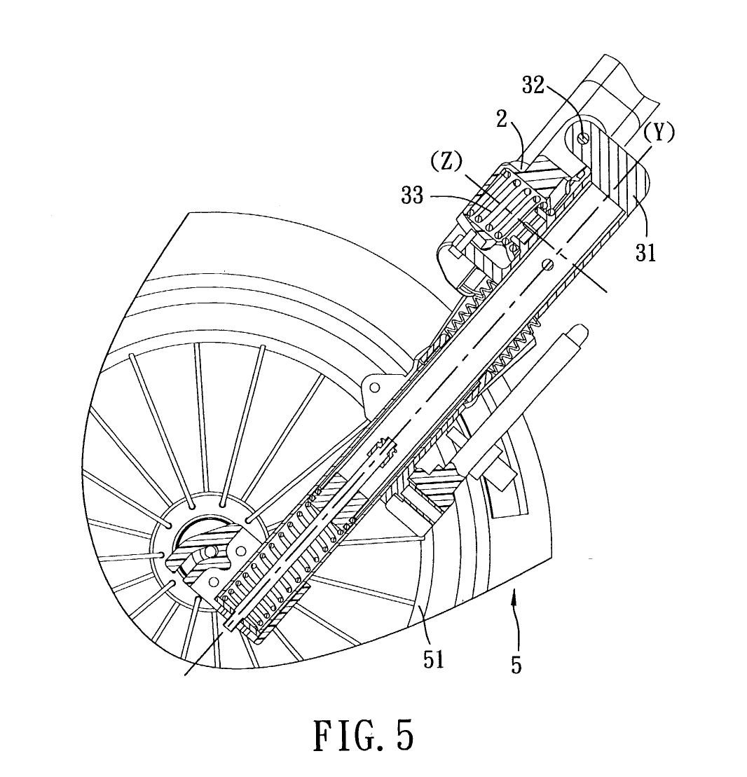

The second shock absorbing unit includes at least one urging member 33 (two urging members 33 are used in the preferred embodiment shown in FIG. 3) that is in the form of a first coil spring, and that is disposed between and that abuts against the bridging member 2 and the upper seat member 3 so as to oscillate between a transverse compression stroke (see FIG. 5), in which, the first shock absorbing unit turns together with the front wheel unit 5 about the first axis against an urging force of the urging member 33 toward the bridging member 2 to compress the urging member 33, and a transverse extension stroke (see FIG. 4), in which, the urging member 33 urges the first shock absorbing unit and the front wheel unit 5 to turn away from the bridging member 2, thereby absorbing shock transmitted from the front wheel unit 5 in a third axis (Z) that is perpendicular to the second axis (Y) when the external force is applied to the wheel 51.

The upper seat member 3 further includes a pair of opposing tubular stationary parts 428 that have top and bottom ends and that extend in the second axis (Y). A curved bridging plate 41 spans over a top end of the wheel 51, and has two clamping ends 412 respectively fixed to the tubular stationary parts 428. A bellow sheath 429 is sleeved on the tubular stationary parts 428 above the bridging plate 41. The pivotal part 30 has a pair of opposing tubular portions 31 that are respectively and securely sleeved on the top ends of the tubular stationary parts 428 via a pair of pins 420 extending therethrough and that have top and bottom ends, a cross portion 312 interconnecting the top ends of the tubular portions 31, a pair of pivotal ears 313 that respectively project from the top ends of the tubular portions 31 toward the bridging member 2, and a pair of positioning protrusions 316 that respectively project from the tubular portions 31 between the top and bottom ends of the tubular portions 31 toward the bridging member 2. The bridging member 2 further has top and bottom ends, a pair of opposing pivotal seats 24 that project upwardly from the top end of the bridging member 2 and that are respectively pivoted to the pivotal ears 313 via pivots 32 so as to permit the upper seat member 3 to be turnable about the first axis, and a pair of opposing cylindrical spring receiving parts 22 that project from the bottom end of the bridging member 2 toward the tubular portions 31 and that define two spring receiving recesses 223. Each of the urging members 33 has one end received in a respective one of the spring receiving recesses 223, and the other end sleeved on a respective one of the positioning protrusions 316.

Each of the spring receiving parts 22 has a bottom side, and a pair of parallel ribs 224 that project downwardly from the bottom side of the spring receiving part 22, and that define a slot 225 therebetween which has front and rear ends. Each of the spring receiving parts 22 further has a bolt stopper 226 that is disposed at the rear end of the slot 225. Each of the tubular portions 32 of the pivotal part 30 further has a bolt seat 317 that projects therefrom to a position underneath the slot 225 in a respective one of the spring receiving parts 22, and a bolt 34 that threadedly engages and that extends through the bolt seat 317 and into the slot 225, that engages the bolt stopper 226 of a respective one of the spring receiving parts 22 during the extension stroke of the urging member 33, and that moves away from the bolt stopper 226 along the slot 225 during the compression stroke of the urging member 33.

Each of the lower movable members 4 includes a tubular movable part 421 that has a top end slidably sleeved on a respective one of the tubular stationary parts 428 via a coupling member 422 fixed thereto, and a bottom end.

The first shock absorbing unit further includes a pair of spring fixing members 425, each of which is fixed and is disposed in the bottom end of a respective one of the tubular stationary parts 428, and a pair of movable rods 424, each of which has one end extending through a respective one of the spring fixing members 425 and into a respective one of the tubular stationary parts 428, and the other end extending through the tubular movable part 421 of a respective one of the lower movable members 4. The first shock absorbing unit further includes a pair of rod stoppers 427, each of which is fixed to the end of a respective one of the movable rods 424, a pair of spring engaging plates 423, each of which is fixed to the other end of a respective one of the movable rods 424 in a respective one of the tubular movable parts 421, and a pair of sleeves 53, each of which is sleeved on the bottom end of a respective one of the tubular movable parts 421, each of which has a flange portion 531 that abuts against a respective one of the spring engaging plates 423, and each of which is mounted on a respective one of the opposite ends of the axle 52. The first shock absorbing unit further includes a pair of second coil springs 426, each of which is disposed in a respective one of the tubular movable parts 421 and each of which has one end fixed to a respective one of the spring fixing members 425, and the other end abutting against a respective one of the spring engaging plates 423 so as to oscillate between a longitudinal compression stroke, in which, each of the tubular movable parts 421 moves upwardly together with a respective one of the movable rods 424, a respective one of the spring engaging plates 423 and the front wheel unit 5 relative to the tubular stationary parts 428 in the second axis (Y) against an urging force of a respective one of the second coil springs 426 so as to compress the second coil spring 426, and a longitudinal extension stroke, in which, the second coil spring 426 urges the tubular movable part 421, the movable rod 424, the spring engaging plate 423, and the front wheel unit 5 to move downwardly relative to the tubular stationary part 428 in the second axis (Y), thereby absorbing the shock transmitted from the front wheel unit 5 in the second axis (Y) when the external force is applied to the wheel 51.

With the first and second shock absorbing units, the aforementioned drawback associated with the prior art can be eliminated.

With the invention thus explained, it is apparent that various modifications and variations can be made without departing from the spirit of the present invention. It is therefore intended that the invention be limited only as recited in the appended claims.

I claim:

1. A stroller comprising:
a stroller frame having a pair of opposing front legs that are inclined at an angle relative to a vertical line, and that have bottom ends;
a front wheel unit disposed below and between said bottom ends of said front legs, and including a wheel and an axle that extends through a center of said wheel, that permits turning of said wheel thereabout, and that has two opposite ends;
a bridging member disposed above said front wheel unit and having two opposite connecting ends that are respectively and securely connected to said bottom ends of said front legs;
a first shock absorbing unit including an upper seat member that has a pivotal part disposed rearwardly of and pivoted to said bridging member so as to be turnable relative to said bridging member about a first axis that is parallel to said axle, said first shock absorbing unit further including a pair of lower movable members that are disposed below said upper seat member, and that are securely and respectively connected to said opposite ends of said axle and that are movable in a second axis toward and away from said upper seat member so as to absorb shock transmitted from said front wheel unit in said second axis and so as to be turnable together with said front wheel unit about said first axis along with said upper seat member when an external force is applied to said wheel in an upward direction parallel to said vertical line; and
a second shock absorbing unit including at least one urging member that is disposed between and that abuts against said bridging member and said upper seat member so as to oscillate between a transverse compression stroke, in which, said first shock absorbing unit turns together with said front wheel unit about said first axis against an urging force of said urging member toward said bridging member to compress said urging member, and a transverse extension stroke, in which, said urging member urges said first shock absorbing unit and said front wheel unit to turn away from said bridging member, thereby absorbing shock transmitted from said front wheel unit in a third axis that is perpendicular to said second axis when the external force is applied to said wheel.

2. The stroller of claim 1, wherein said upper seat member further includes a pair of opposing tubular stationary parts that have top and bottom ends and that extend in said second axis, said pivotal part having a pair of opposing tubular portions that are respectively and securely sleeved on said top ends of said tubular stationary parts and that have top and bottom ends, a cross portion interconnecting said top ends of said tubular portions, a pair of pivotal ears that respectively project from said top ends of said tubular portions toward said bridging member, and a pair of positioning protrusions that respectively project from said tubular portions between said top and bottom ends of said tubular portions toward said bridging member, said bridging member further having top and bottom ends, a pair of opposing pivotal seats that project upwardly from said top end of said bridging member and that are respectively pivoted to said pivotal ears so as to permit said upper seat member to be turnable about said first axis, and a pair of opposing cylindrical spring receiving parts that project from said bottom end of said bridging member toward said tubular portions and that define two spring receiving recesses, said urging member including a pair of first coil springs, each of which has one end received in a respective one of said spring receiving recesses, and the other end sleeved on a respective one of said positioning protrusions.

3. The stroller of claim 2, wherein each of said spring receiving parts has a bottom side, and a pair of parallel ribs that project downwardly from said bottom side and that define a slot therebetween, said slot having front and rear ends, each of said spring receiving parts further having a bolt stopper that is disposed at said rear end of said slot, each of said tubular portions of said pivotal part further having a bolt seat that projects therefrom to a position underneath said slot in a respective one of said spring receiving parts, and a bolt that threadedly engages and that extends through said bolt seat and into said slot, that engages said bolt stopper of a respective one of said spring receiving parts during the compression stroke of said urging member, and that moves away from said bolt stopper along said slot during the extension stroke of said urging member.

4. The stroller of claim 3, wherein each of said lower movable members includes a tubular movable part that has a top end slidably sleeved on a respective one of said tubular stationary parts and a bottom end, said first shock absorbing unit further including a pair of spring fixing members, each of which is fixedly disposed in said bottom end of a respective one of said tubular stationary parts, and a pair of movable rods, each of which has one end extending through a respective one of said spring fixing members and into a respective one of said tubular stationary parts, and the other end extending through said tubular movable part of a respective one of said lower movable members, said first shock absorbing unit further including a pair of rod stoppers, each of which is fixed to said one end of a respective one of said movable rods, a pair of spring engaging plates, each of which is fixed to the other end of the respective one of said movable rods in a respective one of said tubular movable parts, and a pair of sleeves, each of which is sleeved on said bottom end of a respective one of said tubular movable parts, each of which has a flange portion that abuts against a respective one of said spring engaging plates, and each of which is mounted on a respective one of said opposite ends of said axle, said first shock absorbing unit further including a pair of second coil springs, each of which is disposed in a respective one of said tubular movable parts and each of which has one end fixed to a respective one of said spring fixing members, and the other end abutting against a respective one of said spring engaging plates so as to oscillate between a longitudinal compression stroke, in which, each of said tubular movable parts moves upwardly together with a respective one of said movable rods, a respective one of said spring engaging plates and said front wheel unit relative to said tubular stationary parts in said second axis against an urging force of a respective one of said second coil springs to compress said second coil spring, and a longitudinal extension stroke, in which, each of said second coil springs urges the respective one of said tubular movable parts, the respective one of said movable rod, the respective one of said spring engaging plates, and said front wheel unit to move downwardly relative to said tubular stationary part in said second axis, thereby absorbing the shock transmitted from said front wheel unit in said second axis when the external force is applied to said wheel.
